(19) United States
(12) Patent Application Publication
(10) Pub. No.: US 2013/0080718 A1
(43) Pub. Date: Mar. 28, 2013

(54) SEMICONDUCTOR MEMORY DEVICE AND METHOD OF OPERATING THE SAME

(71) Applicant: Hwang HUH, Cheongju-si (KR)

(72) Inventor: Hwang HUH, Cheongju-si (KR)

(73) Assignee: SK hynix Inc., Icheon-si (KR)

(21) Appl. No.: 13/602,088

(22) Filed: Aug. 31, 2012

(30) Foreign Application Priority Data
Sep. 28, 2011 (KR) 10-2011-0098591

(51) Int. Cl. G06F 12/00

(52) U.S. Cl. 711/154; 711/E12.001

(57) ABSTRACT

A semiconductor memory device includes a memory string including memory cells formed by word lines covering a vertical semiconductor layer on a semiconductor substrate at different heights, the memory string coupled between a bit line and a source line, a control circuit configured to control an erase operation of the memory cells, a first erase verify operation of the memory cells coupled to even word lines, and a second erase verify operation of the memory cells coupled to odd word lines, and an operation circuit, performing the erase operation of the memory cells, applying a first voltage to the odd and even word lines to form a channel in the vertical semiconductor layer between the odd and even word lines when the first and second erase verify operations are performed, respectively.

### CROSS-REFERENCE TO RELATED APPLICATION

The present application claims priority to Korean patent application number 10-2011-0098591 filed on Sep. 28, 2011, the disclosure of which is incorporated herein by reference in its entirety.

### BACKGROUND

1. Field of Invention

An embodiment of the present invention relates to a semiconductor memory device and a method of operating the same, more particularly, to a semiconductor memory device having word lines and a method of operating the same.

2. Related Art

A memory array that has a three-dimensional structure or novel structure has been proposed to highly integrate devices within the memory device. With the change in structure of the memory array, a new operating method and new peripheral circuits for implementing the same need to be correspondingly developed in order to improve operating characteristics.

### BRIEF SUMMARY

An embodiment relates to a semiconductor memory device capable of improving operating characteristics and reliability and a method of operating the same.

A semiconductor memory device according to an embodiment of the present invention includes a memory string, a control circuit, and an operation circuit. The memory string includes memory cells formed by word lines covering a vertical semiconductor layer on a semiconductor substrate at different heights, and is coupled between a bit line and a source line. The control circuit is configured to control an erase operation of the memory cells, a first erase verify operation of the memory cells coupled to even word lines among the word lines, and a second erase verify operation of the memory cells coupled to odd word lines. The operation circuit, controlled by the control circuit, performs the erase operation of the memory cells, applying a first voltage to the odd word lines to form a channel in the vertical semiconductor layer between the odd word lines when the first erase verify operation is performed, and applying the first voltage to the even word lines to form a channel in the vertical semiconductor layer between the even word lines when the second erase verify operation is performed.

A method of operating a semiconductor memory device according to an embodiment of the present invention includes performing an erase operation on memory cells formed by word lines covering a vertical semiconductor layer on a semiconductor substrate at different heights that are coupled between a bit line and source line, forming a channel in the vertical semiconductor layer between odd word lines among the word lines, performing a first erase verify operation by applying a second voltage to even word lines among the word lines, forming a channel in the vertical semiconductor layer between the even word lines, and performing a second erase verify operation by applying the second voltage to the odd word lines.

### BRIEF DESCRIPTION OF THE DRAWINGS

FIG. 1 is a circuit diagram of a semiconductor memory device according to an embodiment of the present invention,

FIGS. 2A and 2B are views of a memory string, included in a memory block of FIG. 1, according to an embodiment of the present invention,

FIGS. 3A and 3B are views of a memory string, included in a memory block of FIG. 1, according to an embodiment of the present invention,

FIGS. 4A and 4B are a plan view and a cross-sectional view of a memory cell of the memory string of FIGS. 2A and 3A,

FIG. 5 is a flowchart illustrating a method of operating a semiconductor memory device according to an embodiment of the present invention, and

FIGS. 6A to 6D are views illustrating the method of operating a semiconductor memory device according to an embodiment of the present invention.

### DESCRIPTION OF EMBODIMENTS

Hereinafter, various embodiments of the present disclosure will be described in detail with reference to the accompanying drawings. The figures are provided to allow those having ordinary skill in the art to understand the scope of the embodiments of the disclosure. The present invention may, however, be embodied in different forms and should not be construed as limited to the embodiments set forth herein. Rather, these embodiments are provided so that this disclosure will be thorough and complete, and will fully convey the scope of the present invention to those skilled in the art.

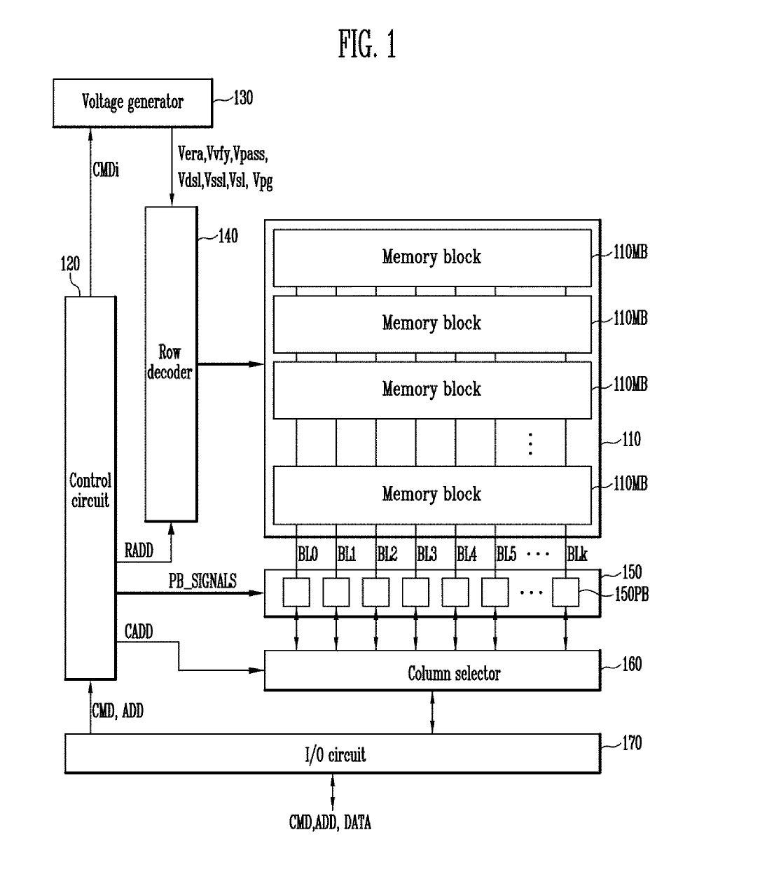

FIG. 1 is a circuit diagram of a semiconductor memory device according to an embodiment of the present invention.

Referring to FIG. 1, the semiconductor memory device may include a memory array 110, operation circuits 130 to 170, and a control circuit 120.

The memory array 110 may include a plurality of memory blocks 110 MB. Each of the memory blocks 110 MB may include memory strings that are coupled between bit lines and a source line. A detailed structure of the memory strings will be described below.

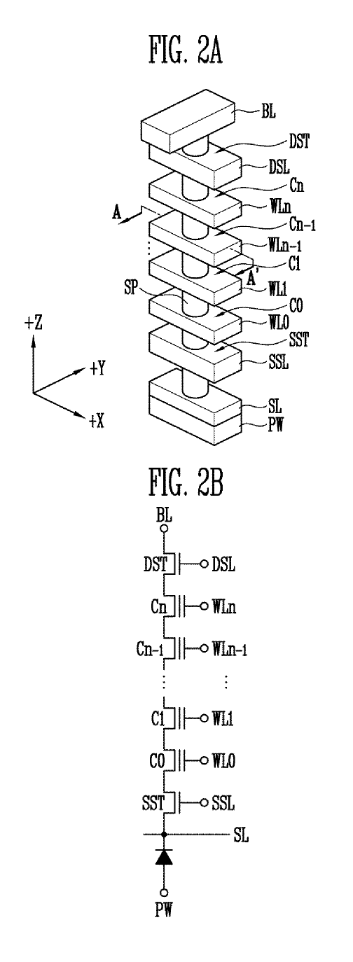

FIGS. 2A and 2B are views of a memory string, included in at least one of the memory blocks of FIG. 1, according to an embodiment of the present invention.

Referring to FIGS. 2A and 2B, a source line SL may be formed on a semiconductor substrate in which a P well PW is formed. A vertical channel layer SP may be formed on the source line SL. A bit line BL may be coupled to the top of the vertical channel layer SP. The vertical channel layer SP may be formed of polysilicon. A plurality of conductive layers (SSL, WL0 to WLn, and DSL) may surround at different positions of the vertical channel layer SP. A layer stack (not shown) that includes a charge trap layer may be formed on the surface of the vertical channel layer SP. The layer stack may also be located between the vertical channel layer SP and the conductive layers (SSL, WL0 to WLn, and DSL).

The lowermost conductive layer may be a source select line SSL, whereas the uppermost conductive layer may be a drain select line DSL. The intermediate conductive layers between the source and drain select lines SSL and DSL may be word lines WL0 to WLn. The conductive layers (SSL, WL0 to WLn, and DSL) may be formed at different heights on the vertical channel layer SP and stacked upon one another on the semiconductor substrate. The vertical channel layer SP passing through the conductive layers (SSL, WL0 to WLn, and DSL) may vertically extend between the bit line BL and the source line SL formed on the semiconductor substrate.

A drain select transistor DST may be formed at a position in which the uppermost conductive layer (DSL) surrounds the vertical channel layer SP, and a source select transistor SST may be formed at a position in which the lowermost conductive layer (SSL) surrounds the vertical channel layer SP. Memory cells C0 to Cn may be formed at positions in which the intermediate conductive layers (WL0 to WLn) surround the vertical channel layer SP.

The memory string having the above-described structure, which includes the source select transistor SST, the memory cells C0 to Cn, and the drain select transistor DST, which are all located between the source line SL and the bit line BL and vertically coupled to the semiconductor substrate, is called a Bit Cost Scalable (BiCS) structure.

A memory string having another structure is described below.

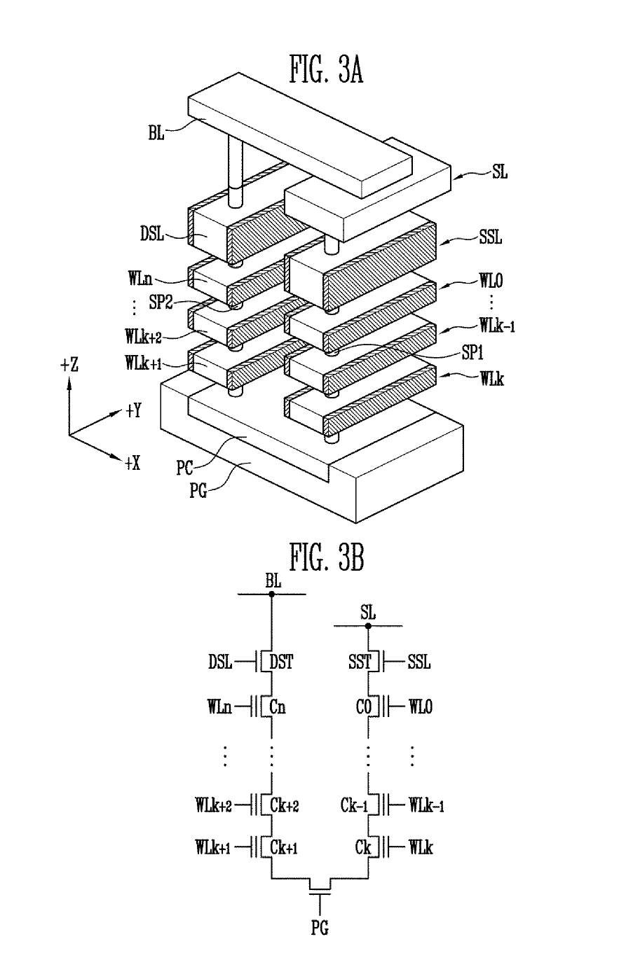

FIGS. 3A and 3B are views of a memory string, included in at least one of the memory blocks of FIG. 1, according to an embodiment of the present invention.

Referring to FIGS. 3A and 3B, a pipe gate PG that includes a recessed portion may be formed over the semiconductor substrate (not shown), and a pipe channel layer PC may be formed in the recessed portion of the pipe gate PG. A plurality of vertical channel layers (SP1 and SP2) may be formed on the pipe channel layer PC. The top of the first vertical channel layer SP1 may be coupled to the source line SL, whereas the top of the second vertical channel layer SP2 may be coupled to the bit line BL. The first and second vertical channel layers SP1 and SP2 each may be formed of polysilicon.

One group of conductive layers (WL0 to WLk and SSL) may surround the first vertical channel layer SP1 at different heights. In addition, the other group of conductive layers (WLk+1 to WLn and DSL) may surround the second vertical channel layer SP2 at different heights. A layer stack (not shown) that includes a charge storage layer may be formed on surfaces of the vertical channel layers SP1 and SP2 and the surface of the pipe channel layer PC. The layer stack may also be located between the first vertical channel layer SP1 and the conductive layers (WL0 to WLk and SSL), between the second vertical channel layer SP2 and the conductive layers (WLk+1 to WLn and DSL), and between the pipe channel layer PC and the pipe gate PG.

The uppermost conductive layer that surrounds the first vertical channel layer SP1 may be the source select line SSL, and the other conductive layers located under the source select line SSL may be word lines WL0 to WLk. The uppermost conductive layer that surrounds the second vertical channel layer SP2 may be the drain select line DSL, and the other conductive layers located under the drain select line DSL may be word lines WLk+1 to WLn.

In other words, a pair of groups consisting of the conductive layers (SSL, WL0 to WLn, and DSL) may be stacked upon one another on the semiconductor substrate. The first vertical channel layer SP1 passing through the conductive layers (SSL and WL0 to WLk) may vertically extend between the source line SL and the pipe channel layer PC. The second vertical channel layer SP2 passing through the conductive layers (DSL and WLk+1 to WLn) may vertically extend between the bit line BL and the pipe channel layer PC.

A source select transistor SST may be formed at a position in which the uppermost conductive layer (SSL) surrounds the first vertical channel layer SP1, and memory cells C0 to Ck may be formed at positions in which the other conductive layers (WL0 to WLk) surround the first vertical channel layer SP1. A drain select transistor DST may be formed at a position in which the uppermost conductive layer (DSL) surrounds the second vertical channel layer SP2. Memory cells Ck+1 to Cn may be formed at positions in which the other conductive layers (WLk+1 to Wn) surround the second vertical channel layer SP2.

The memory string having the above-described structure, which includes the source select transistor SST and memory cells C0 to Ck, which are formed between the source line SL and the pipe channel layer PC and vertically coupled to the substrate, and the drain select transistor DST and memory cells Ck+1 to Cn, which are formed between the bit line BL and the pipe channel layer PC and vertically coupled to the substrate, is called a Pipe-shaped Bit Cost Scalable (P-BiCS) structure.

The conductive layer formed over or under the source select line SSL may become a first pass word line, and the conductive layer formed over or under the drain select line DSL may be a second pass word line. The first and second pass word lines may block threshold voltages of the memory cells coupled to the first word line WL0 or the last word line WLn from being affected by interference.

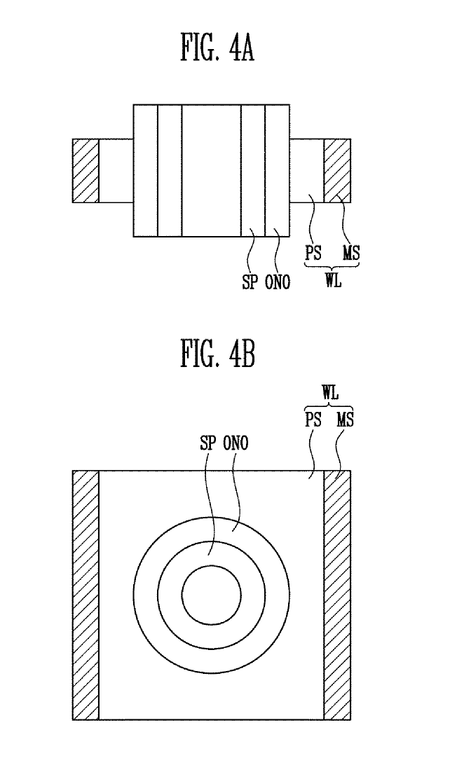

The structure of the memory cell as illustrated in FIG. 2A or FIG. 3A is described below in more detail. FIGS. 4A and 4B are a plan view and a cross-sectional view of one of the memory cells in the memory string of FIG. 3A.

Referring to FIGS. 4A and 4B, the vertical channel layer SP may have a cylindrical shape defining a cavity therein. The vertical channel layer SP may be formed of a semiconductor material. In particular, the vertical channel layer SP may be formed of a polysilicon layer doped with a pentavalent impurity at a concentration that does not cause the polysilicon layer to exhibit electrical conductivity, or a polysilicon layer doped with no impurities. A layer stack ONO that includes a charge trap layer may surround the vertical channel layer SP. The layer stack ONO may have a tunnel insulating layer, a charge trap layer, and a blocking insulating layer stacked one upon another. The tunnel insulating layer may be formed of an oxide layer, the trap charge layer may be formed of a nitride layer, and the blocking insulating layer may be formed of an oxide layer or a high dielectric insulating layer having a higher dielectric constant than the nitride layer. The tunnel insulating layer may be located between the charge trap layer and the vertical channel layer SP. The conductive layers may surround the vertical channel layer SP at different heights. In one example, the conductive layer used as the word line WL may be formed of a polysilicon layer PS, and the outside wall of the conductive layer may be formed of metal silicide MS. The layer stack ONO may be located between the vertical channel layer SP and the word line WL.

Referring to FIGS. 1 and 2A, the control circuit 120 is configured to perform an erase operation on the memory cells C0 to Cn included in the selected memory block, a first erase verify operation on the memory cells C0 to Cn−1 coupled to even word lines WL0 to WLn−1, respectively, among the word lines WL0 to WLn, and a second erase verify operation on the memory cells C1 to Cn coupled to odd word lines WL1 to WLn, respectively. The control circuit 120 may output an internal command signal CMDi to perform an erase operation or an erase verify operation in response to a command signal CMD being externally input through an I/O circuit 170. In addition, the control circuit 120 may output PB control signals PB_SIGNALS to control page buffers 150PB included in a page buffer group 150 depending on the type of operation. The control circuit 120 may output a row address signal RADD and a column address signal CADD in response to an address signal ADD being externally input through the I/O circuit 170.

The operation circuits (130 to 170) are configured to apply a first voltage Vpass to the odd word lines WL1 to WLn in order to form a channel in the vertical channel layer SP between the memory cells C0 to Cn when the first erase verify operation is performed after the erase operation is performed on the memory cells C0 to Cn under control of the control circuit 120. In addition, the operation circuits (130 to 170) are configured to apply the first voltage Vpass to the even word lines WL0 to WLn−1 to form a channel in the vertical channel layer SP between the even word lines WL0 to WLn−1 when the second erase verify operation is performed.

These operation circuits may include a voltage generator 130, a row decoder 140, the page buffer group 150, a column selector 160, and the I/O circuit 170.

The voltage generator 130 may output operating voltages (e.g., Vera, Vvfy, Vpass, Vdsl, Vssl, Vsl, and Vpg) to perform the erase operation and the erase verify operation of the memory cells in response to the internal command signal CMDi output from the control circuit 120.

The row decoder 140 may couple global lines and local lines (DSL, WL0 to WLn, and SSL) to each other in response to the row address signal RADD output from the control circuit 120 so that the operating voltages output to the global lines from the voltage generator 130 are able to be transferred to the local lines (DSL, WL0 to WLn, and SSL) of the memory block 110MB selected from the memory array 110.

When the operating voltages output from the voltage generator 130 are transferred to the memory block 110MB selected by the row decoder 140, an erase operation and an erase verify operation are performed on the memory cells included in the selected memory block 110MB. A detailed description of the erase operation and the erase verify operation will be described below.

The page buffer group 150 may include the plurality of page buffers 150PB that are coupled to the memory array 110 through bit lines BL0 to BLk. The page buffers 150PB of the page buffer group 150 may precharge the bit lines in response to the PB control signals PB_SIGNALS output from the control circuit 120 or sense changes in voltages of the bit lines.

The column selector 160 may select the page buffers 150PB included in the page buffer group 150 in response to the column address signal CADD output from the control circuit 120. The column selector 160 may sequentially transfer data to be stored in the memory cells to the page buffers 150PB in response to the column address signal CADD. In addition, the column selector 160 may sequentially select the page buffers 150PB in response to the column address signal CADD such that the data of the memory cells latched to the page buffers 150PB can be externally output during the read operation.

The I/O circuit 170 may transfer data input externally into the column selector 160 under control of the control circuit 120 such that the externally input data can be input to the page buffer group 150 so as to store the data in the memory cells during a program operation. When the column selector 160 transfers the data from the I/O circuit 170 to the page buffers 150PB of the page buffer group 150 in the above-described manner, the page buffers 150PB may store the input data to latch circuits therein. In addition, the I/O circuit 170 may externally output the data transferred from the page buffers 150PB of the page buffer group 150 through the column selector 160 during the read operation.

The above-described memory strings (refer to FIGS. 2A and 3A) each may have memory cells that are located between the bit line and the substrate (i.e., the source line or the pipe channel layer) and are vertically coupled to the substrate, thereby reducing the area of the memory cells. In addition, since the vertical channel layer passes through the word lines, a source or drain may not be formed in the vertical channel layer between the word lines.

The vertical channel layer in which a channel is formed may be formed of a semiconductor material such as a polysilicon layer, and a source or drain may not be formed in the semiconductor layer between the word lines by ion implantation. When a source or drain is not formed in the semiconductor layer between the word lines, if a voltage of 0V is applied to every word line during an erase verify operation, free electrons may not be generated in the semiconductor layer between the word lines. As a result, it becomes difficult to perform the erase verify operation. For these reasons, the erase verify operation is performed when a bias voltage that is greater than 0V and large enough to cause free electrons to gather at the surface of the semiconductor layer between the word lines to form a channel therein is applied to the word lines. However, when a voltage greater than 0V is applied to the word lines during the erase verify operation, an erase verify level may not be reduced to less than 0V.

A threshold voltage of the memory cell that is sensed during the erase verify operation is affected by resistance of the channel formed in the semiconductor layer between the word lines. A pass voltage having a high level is applied to unselected word lines during the read operation and the program verify operation, which may cause a channel to be sufficiently formed. As a result, threshold voltage sensing conditions for an erase verify operation may differ from those for a read operation and a program verify operation, and threshold voltages of the memory cells may be incorrectly sensed during the erase verify operation.

The threshold voltage sensing conditions for an erase verify operation need to be set to equal to those for a read operation or a program verify operation, which will be described below.

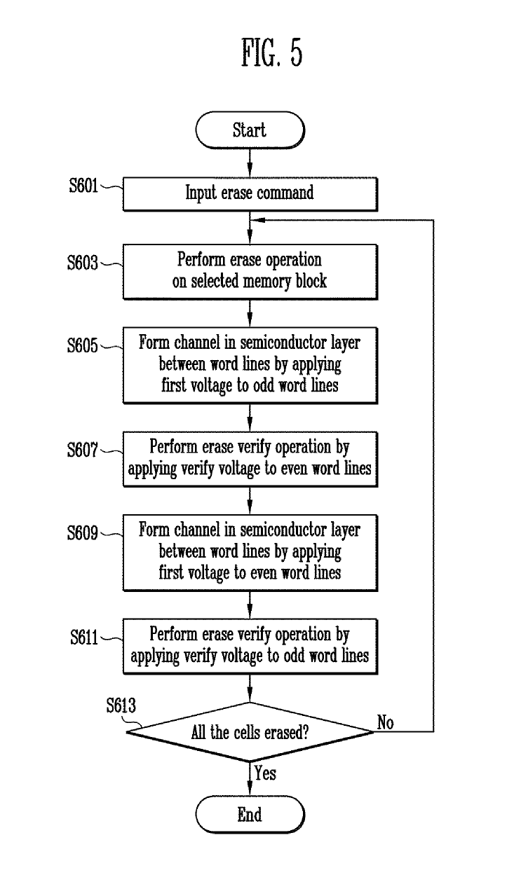

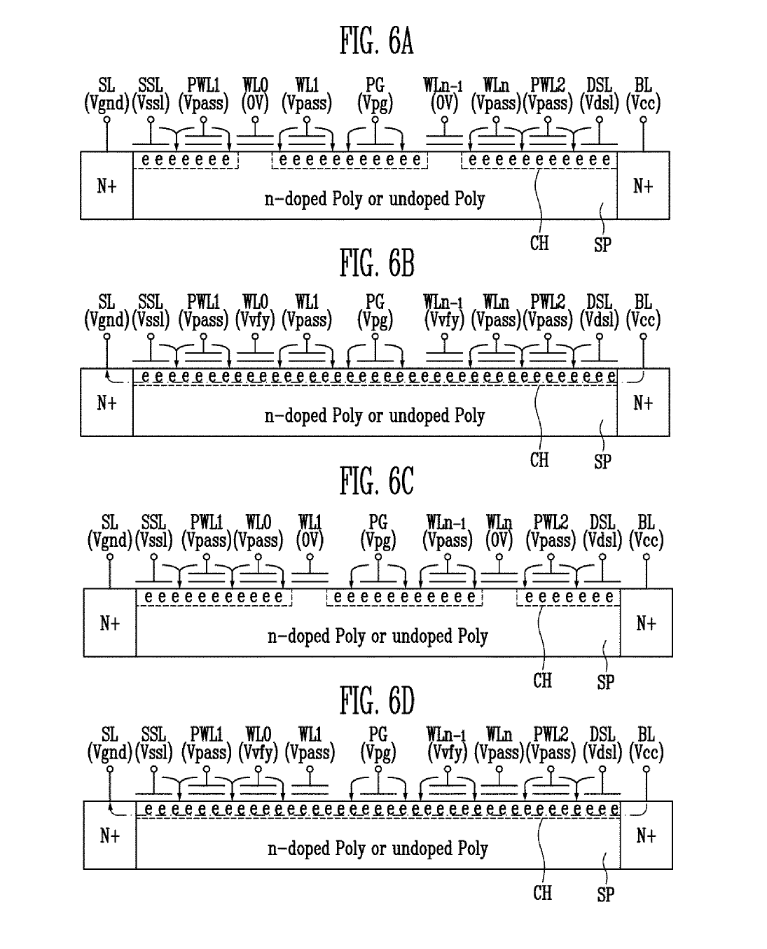

FIG. 5 is a flowchart illustrating a method of operating a semiconductor memory device according to an embodiment of the present invention. FIGS. 6A to 6D are views illustrating the method of operating a semiconductor memory device according to an embodiment of the present invention.

Referring to FIG. 5, an erase command may be input at step S601. At this point, an address of a memory block on which an erase operation is performed may also be an input.

The erase operation may be performed on a selected memory block at step S603. According to an embodiment of the erase operation, hot-hole injection may be performed to supply hot holes to a vertical channel layer of a memory string. To perform the hot-hole injection, word lines may be set to be in a floating state, and a ground voltage may be applied to a source select line. In addition, when a hot-hole injection voltage is applied to the source line SL, hot holes may be injected into the vertical channel layer by gate-induced drain leakage (GIDL) current.

After a sufficient amount of time has passed to inject hot holes into the vertical channel layer, the hot-hole injection voltage being applied to the source line SL may be changed to an erase voltage, which has a higher voltage level than the hot-hole injection voltage. The source select line may be set to be in a floating state. When the erase voltage is applied, voltages of the source select line and the word lines in the floating state may be increased due to capacitive coupling.

Subsequently, when the ground voltage is applied to the word lines, a sufficiently large voltage difference may be applied between the word lines and the vertical channel layer, so that electrons trapped in the charge trap layer located between the vertical channel layer and the word lines are emitted to the vertical channel layer. Thereafter, when the supply of the erase voltage is cut off, the erase operation is completed.

Referring to FIGS. 5 and 6A, a channel may be formed in the vertical channel layer SP between the odd word lines WL1 to WLn among the word lines WL0 to WLn at step S605. The first voltage Vpass may be applied to the odd word lines WL1 to WLn. The bit line BL coupled to the vertical channel layer SP through one junction N+ may be precharged to a power voltage Vcc, and a ground voltage Vgnd may be applied to the source line SL coupled to the vertical channel layer SP through the other junction N+. In addition, the first voltage Vpass may be applied to pass word lines PWL1 and PWL2, and select voltages Vssl and Vdsl may be applied to select lines SLL and DSL, respectively, to turn on select transistors. In addition, when the pipe gate PG is included, a pipe voltage Vpg may be applied to the pipe gate PG.

In this manner, free electrons may gather at the surface of the vertical channel layer SP between all the lines (SSL, PWL1, WL0, WL1, PG, WLn−1, WLn, PWL2, and DSL) to thereby form a channel CH therein. In addition, the channel CH may further be formed in the surface of the vertical channel layer SP that faces the select lines SLL and DSL to which the select voltages Vssl and Vdsl are applied and in the surface of the vertical channel layer SP that faces the pass word lines PWL1 and PWL2 and the odd word lines WL1 to WLn to which the first voltage Vpass is applied. When a ground voltage (0V) is applied to the even word lines WL0 to WLn−1, a channel may not be formed in the surface of the vertical channel layer SP that faces the even word lines WL0 to WLn−1. Only the memory cells coupled to the even word lines WL0 to WLn−1 may be turned off.

Referring to FIGS. 5 and 6B, an erase verify operation may be performed on the memory cells coupled to the even word lines WL0 to WLn−1 at step S607. A second voltage Vvfy corresponding to an erase verify voltage may be applied to the even word lines WL0 to WLn−1. The second voltage Vvfy may have a lower voltage level than the first voltage Vpass. When all of the threshold voltages of even memory cells coupled to the even word lines WL0 to WLn−1 become lower than the target level, the channel CH may further be formed in the surface of the vertical channel layer SP that corresponds to channel regions of the even memory cells (i.e., the surface of the vertical semiconductor layer facing the even word lines). As a result, the channel CH may be connected from the bit line BL to the source line SL, and the precharged voltage of the bit line BL may be reduced. On the other hand, when there is even one non-erased memory cell that has a threshold voltage greater than the target level, among the even memory cells coupled to the even word lines WL0 to WLn−1, a channel may not be formed in the surface of the vertical channel layer SP that corresponds to the channel region of the non-erased memory cell. As a result, the channel CH may not be connected from the bit line BL to the source line SL, and the precharged voltage of the bit line BL may be maintained.

The page buffers circuit (see reference character 150PB of FIG. 1) may sense voltages of the bit lines and latch a first erase result corresponding to erase states of the even memory cells coupled to the even word lines WL0 to WLn−1.

As described above, the second voltage Vvfy is applied after the first voltage Vpass is applied. However, the first voltage Vpass and the second voltage Vvfy may be applied at the same time. In other words, step S605 and step S607 may be performed at the same time.

Referring to FIGS. 5 and 6C, a channel may be formed in the vertical channel layer SP between the even word lines WL0 to WLn−1 among the word lines WL0 to WLn at step S609. The first voltage Vpass may be applied to the even word lines WL0 to WLn−1. The bit line BL coupled to the vertical channel layer SP through one junction N+ may be precharged to the power voltage Vcc, and the ground voltage Vgnd may be applied to the source line SL coupled to the vertical channel layer SP through the other junction N+. In addition, the first voltage Vpass may also be applied to the pass word lines PWL1 and PWL2, and the select voltages Vssl and Vdsl may be applied to the select lines SLL and DSL, respectively, to turn on the select transistors. Also, when the pipe gate PG is included, the pipe voltage Vpg may be applied to the pipe gate PG.

In this manner, free electrons gather at the surface of the vertical channel layer SP between all of the lines (SSL, PWL1, WL0, WL1, PG, WLn−1, WLn, PWL2, and DSL) to thereby form the channel CH therein. In addition, the channel CH may further be formed in the surface of the vertical channel layer SP that faces the select lines SLL and DSL to which the select voltages Vssl and Vdsl are applied, and in the surface of the vertical channel layer SP that faces the pass word lines PWL1 and PWL2 and the even word lines WL0 to WLn−1 to which the first voltage Vpass is applied. When the ground voltage (0V) is applied to the odd word lines WL1 to WLn, a channel may not be formed in the surface of the vertical channel layer SP that faces the odd word lines WL1 to WLn. Only the memory cells coupled to the odd word lines WL1 to WLn may be turned off.

Referring to FIGS. 5 and 6D, an erase verify operation may be performed on the memory cells coupled to the odd word lines WL1 to WLn at step S611. The second voltage Vvfy corresponding to an erase verify voltage may be applied to the odd word lines WL1 to WLn. The second voltage Vvfy may have a lower voltage level than the first voltage Vpass. When all of the odd memory cells coupled to the odd word lines WL1 to WLn have threshold voltages lower than the target level, the channel CH may further be formed in the surface of the vertical channel layer SP that corresponds to channel regions of the odd memory cells (i.e., the surface of the vertical semiconductor layer facing the odd word lines). As a result, the channel CH may be connected from the bit line BL to the source line SL, and the precharged voltage of the bit line BL may be reduced. On the other hand, when there is even one non-erased memory cell that has a threshold voltage greater than the target level, among the odd memory cells coupled to the odd word lines WL1 to WLn, a channel may not be formed in the surface of the vertical channel layer SP that corresponds to a channel region of the non-erased memory cell. As a result, the channel CH may not be connected from the bit line BL to the source line SL, and the precharged voltage of the bit line BL may be maintained.

The page buffers (see reference character 150PB of FIG. 1) may sense voltages of the bit lines and latch a second erase result corresponding to erase states of the odd memory cells coupled to the odd word lines WL1 to WLn.

Step S609 and step S611 may be performed at the same time. In addition, steps S609 and S611 may precede steps S605 and S607.

At step S613, if it is determined that a non-erased memory cell is present according to the first and second erase results latched to the page buffers (see reference character 150PB of FIG. 1), the control circuit (see reference numeral 120 of FIG. 1) may repeat the erase operation (at S603) on the selected memory block and the subsequent steps S605 to S611. When the threshold voltage of every memory cell becomes lower than the target level, it is determined that the entirety of memory cells have been erased, and the erase operation may be completed.

When it is determined that a non-erased memory cell is present according to the first erase result latched to the page buffers 150PB at step S607, the control circuit 120 may not perform steps S609 and S611 and may repeat the erase operation at step S603.

As set forth above, the first erase verify operation and the second erase verify operation are performed on the even memory cells coupled to the even word lines WL0 to WLn−1, respectively, and the odd memory cells coupled to the odd word lines WL1 to WLn, respectively. A channel is formed in the surface of the vertical semiconductor layer with the exception of a region of the vertical semiconductor layer that faces the selected word line by applying voltage to unselected word lines when the erase verify operation is performed, so that a channel resistance generated in the vertical semiconductor layer during the erase verify operation and a channel resistance generated in the vertical semiconductor layer during another operation (e.g., a read operation or a program verify operation) may be controlled to be the same as each other. As a result, each operation may be performed under the same threshold voltage sensing conditions, thereby enhancing operational reliability.

In addition, since a voltage of 0V can be applied to the selected word lines during the erase verify operation, the threshold voltages of the memory cells can be sensed at an erase verify voltage level less than 0V.

The present invention provides a new operating method and circuits for implementing the same in line with a changed structure of a memory array to increase the degree of integration, thereby increasing operating characteristics and reliability.

1. A semiconductor memory device, comprising:
a memory string including memory cells formed by word lines covering a vertical semiconductor layer on a semiconductor substrate at different heights, the memory string coupled between a bit line and a source line;
a control circuit configured to control an erase operation of the memory cells, a first erase verify operation of even memory cells coupled to even word lines among the word lines and a second erase verify operation of odd memory cells coupled to odd word lines; and
an operation circuit, controlled by the control circuit, performing the erase operation of the memory cells, applying a first voltage to the odd word lines to form channels in the odd memory cells and channels in the vertical semiconductor layer between the odd word lines and the even word lines when the first erase verify operation is performed, and applying the first voltage to the even word lines to form channels in the even memory cells and channels in the vertical semiconductor layer between the even word lines and the odd word lines when the second erase verify operation is performed.

2. The semiconductor memory device of claim 1, wherein the vertical semiconductor layer vertically extends between the bit line and the source line.

3. The semiconductor memory device of claim 1, wherein the memory string includes a first vertical semiconductor layer vertically extending between the bit line and a pipe channel layer provided on the semiconductor substrate and a second vertical semiconductor layer vertically extending between the pipe channel layer and the source line.

4. The semiconductor memory device of claim 1, wherein the operation circuit is configured to apply a ground voltage to the source line, precharge the bit line, and apply the first voltage to the odd word lines during the first erase verify operation and the second erase verify operation.

5. The semiconductor memory device of claim 1, wherein the operation circuit is configured to apply a second voltage to the even word lines when applying the first voltage to the odd word lines during the first erase verify operation.

6. The semiconductor memory device of claim 1, wherein the operation circuit is configured to apply a second voltage to the even word lines after applying the first voltage to the odd word lines during the first erase verify operation.

7. The semiconductor memory device of claim 1, wherein the operation circuit is configured to apply a second voltage to the odd word lines when applying the first voltage to the even word lines during the second erase verify operation.

8. The semiconductor memory device of claim 1, wherein the operation circuit is configured to apply a second voltage to the odd word lines after applying the first voltage to the even word lines during the second erase verify operation.

9. The semiconductor memory device of claim 5, wherein the second voltage has a lower voltage level than the first voltage.

10. A method of operating a semiconductor memory device, the method comprising:
performing an erase operation on memory cells formed by word lines covering a vertical semiconductor layer on a semiconductor substrate at different heights, the memory cells coupled between a bit line and a source line and;
forming a channel in the vertical semiconductor layer between odd word lines among the word lines;
performing a first erase verify operation by applying a second voltage to even word lines among the word lines;
forming a channel in the vertical semiconductor layer between the even word lines; and
performing a second erase verify operation by applying the second voltage to the odd word lines.

11. The method of claim 10, wherein a first voltage is applied to the odd word lines to form the channel in the vertical semiconductor layer between the odd word lines.

12. The method of claim 11, wherein the first voltage and the second voltage are applied at the same time.

13. The method of claim 10, wherein a first voltage is applied to the even word lines to form the channel in the vertical semiconductor layer between the even word lines.

14. The method of claim 13, wherein the first voltage and the second voltage are applied at the same time.

15. The method of claim 11, wherein the second voltage has a lower voltage level than the first voltage.

16. The method of claim 10, wherein the first erase verify operation or the second erase verify operation is performed after a ground voltage is applied to the source line and after the bit line is precharged.

17. The semiconductor memory device of claim 6, wherein the second voltage has a lower voltage level than the first voltage.

18. The semiconductor memory device of claim 7, wherein the second voltage has a lower voltage level than the first voltage.

19. The semiconductor memory device of claim 8, wherein the second voltage has a lower voltage level than the first voltage.

20. The method of claim 13, wherein the second voltage has a lower voltage level than the first voltage.
